(19) United States
(12) Patent Application Publication
(10) Pub. No.: US 2015/0195710 A1
(43) Pub. Date: Jul. 9, 2015

(54) APPARATUS, METHOD AND SYSTEM OF OBFUSCATING A WIRELESS COMMUNICATION NETWORK IDENTIFIER

(71) Applicants: Adam M. Bar-Niv, Tel-Aviv (IL); Tomer Daniel, Herzliya (IL)

(72) Inventors: Adam M. Bar-Niv, Tel-Aviv (IL); Tomer Daniel, Herzliya (IL)

(21) Appl. No.: 14/225,078

(22) Filed: Mar. 25, 2014

Related U.S. Application Data
(60) Provisional application No. 61/924,320, filed on Jan. 7, 2014.

(51) Int. Cl. H04W 12/08; H04L 29/06

(52) U.S. Cl. CPC H04W 12/08; H04L 63/1416

(57) ABSTRACT

Some demonstrative embodiments include devices, systems and methods of obfuscating a wireless communication network identifier. For example, an apparatus may include a radio to communicate a probe request, the probe request from a mobile device to an access point (AP), the probe request including an obfuscated service set identifier (SSID), the obfuscated SSID being different from an actual SSID of the AP.

### CROSS REFERENCE

This application claims the benefit of and priority from U.S. Provisional Patent Application No. 61/924,320 entitled “Apparatus, Method and System of Obfuscating a Wireless Communication Network Identifier”, filed Jan. 7, 2014, the entire disclosure of which is incorporated herein by reference.

### TECHNICAL FIELD

Embodiments described herein generally relate to obfuscating wireless communication network identifiers.

### BACKGROUND

A Wireless-Fidelity (Wi-Fi) mobile device may retain a set of connection (“network”) profiles corresponding to previously connected access points (APs). For example, the connection profiles may include Service Set Identifiers (SSIDs) the APs, e.g., SSIDs of a home AP, a work AP, a regular coffee shop AP, and/or any other AP, which may be utilized by a user of the mobile device.

An operating System (OS) networking stack of the mobile device may periodically search for the set of profiles in order to auto-connect to any of the APs, when found.

In some cases, the mobile device may perform directed scanning for an AP, for example, by sending an unencrypted Probe Request frame with an SSID of the AP being searched for.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a sequence of operations and communications between a mobile device and an access point, in accordance with some demonstrative embodiments.

FIG. 3 is a schematic flow-chart illustration of a method of obfuscating a wireless communication network identifier, in accordance with some demonstrative embodiments.

FIG. 4 is a schematic flow-chart illustration of a method of processing an obfuscated wireless communication network identifier, in accordance with some demonstrative embodiments.

FIG. 5 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, an Ultrabook™ computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 December, 2012); IEEE 802.11 task group ai (TGai)) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “access point” (AP), as used herein, may include an entity that contains one station (STA) and provides access to distribution services, via the Wireless Medium (WM) for associated STAs.

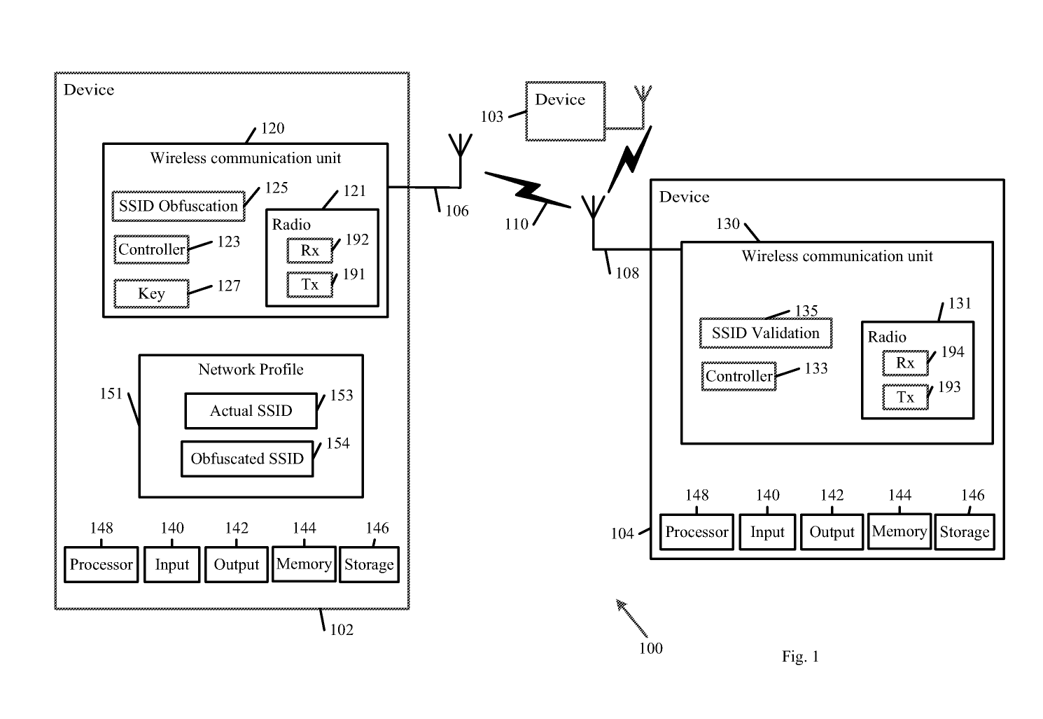

Reference is now made to FIG. 1, which schematically illustrates a block diagram of a system 100, in accordance with some demonstrative embodiments.

As shown in FIG. 1, in some demonstrative embodiments, system 100 may include a wireless communication network including one or more wireless communication devices, e.g., wireless communication devices 102 and/or 104, capable of communicating content, data, information and/or signals over a wireless medium 110, for example, a radio channel, an IR channel, a RF channel, a Wireless Fidelity (WiFi) channel, and the like. One or more elements of system 100 may optionally be capable of communicating over any suitable wired communication links.

In some demonstrative embodiments, wireless communication devices 102 and/or 104 may include wireless communication units 120 and/or 130, respectively, to perform wireless communication between wireless communication devices 102 and/or 104 and/or with one or more other wireless communication devices, e.g., as described below.

In some demonstrative embodiments, wireless communication unit 120 may include at least one radio 121 and/or wireless communication unit 130 may include at least one radio 131. Radios 121 and/or 131 may include, for example, one or more wireless transmitters, receivers and/or transceivers able to send and/or receive wireless communication signals, RF signals, frames, blocks, transmission streams, packets, messages, data items, and/or data. For example, radio 121 may include a transmitter (Tx) 191 and a receiver (Rx) 192; and/or radio 131 may include a transmitter (Tx) 193 and a receiver (Rx) 194.

In some demonstrative embodiments, wireless communication device 102 may include a controller 123 to control communications performed by radio 121, and/or wireless communication device 104 may include a controller 133 to control communications performed by radio 131. In some demonstrative embodiments, at least some of the functionality of controller 123 may be implemented as part of wireless communication unit 120, and/or at least some of the functionality of controller 133 may be implemented as part of wireless communication unit 130. In some embodiments, the functionality of controller 123 may be distributed between wireless communication unit 120 and one or more other elements of wireless communication device 102; and/or the functionality of controller 133 may be distributed between wireless communication unit 130 and one or more other elements of wireless communication device 104. In other embodiments, controller 123 may be implemented as part of any other element of wireless communication device 102, and/or controller 133 may be implemented as part of any other element of wireless communication device 104. In one example, controller 123 and/or controller 133 may include a media access controller and/or any other controller.

In some demonstrative embodiments, wireless communication units 120 and/or 130 may include or may be implemented as part of a wireless Network Interface Card (NIC), and the like.

In some demonstrative embodiments, wireless communication device 102 may include or may be implemented as part of a mobile or portable device. For example, wireless communication device 102 may include or may be implemented as part a mobile computer, a laptop computer, an Ultrabook™ computer, a notebook computer, a tablet computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a cellular telephone, a PCS device, a PDA device which incorporates a wireless communication device, a mobile or portable GPS device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an AN device, a BD player, a BD recorder, a DVD player, a HD DVD player, a DVD recorder, a HD DVD recorder, a PVR, a broadcast HD receiver, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, a music player, or the like.

In some demonstrative embodiments, device 104 may include or may perform the functionality of an Access Point (AP).

In some demonstrative embodiments, device 104 may include a stationary AP located at a predefined location.

Wireless communication devices 102 and/or 104 may include, for example, one or more of a processor 148, an input unit 140, an output unit 142, a memory unit 144, and a storage unit 146. Wireless communication devices 102 and/or 104 may optionally include other suitable hardware components and/or software components. In some demonstrative embodiments, some or all of the components of one or more of wireless communication devices 102 and/or 104 may be enclosed in a common housing or packaging, and may be interconnected or operably associated using one or more wired or wireless links. In other embodiments, components of one or more of wireless communication devices 102 and/or 104 may be distributed among multiple or separate devices.

Processor 148 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 148 executes instructions, for example, of an Operating System (OS) of wireless communication devices 102 and/or 104 and/or of one or more suitable applications.

Input unit 140 includes, for example, a keyboard, a keypad, a mouse, a touch-screen, a touch-pad, a track-ball, a stylus, a microphone, or other suitable pointing device or input device. Output unit 142 includes, for example, a monitor, a screen, a touch-screen, a Light Emitting Diode (LED) display unit, a flat panel display, a Liquid Crystal Display (LCD) display unit, a plasma display unit, a Cathode Ray Tube (CRT) display unit, one or more audio speakers or earphones, or other suitable output devices.

Memory unit 144 includes, for example, a Random Access Memory (RAM), a Read Only Memory (ROM), a Dynamic RAM (DRAM), a Synchronous DRAM (SDRAM), a flash memory, a volatile memory, a non-volatile memory, a cache memory, a buffer, a short term memory unit, a long term memory unit, or other suitable memory units. Storage unit 146 includes, for example, a hard disk drive, a floppy disk drive, a Compact Disk (CD) drive, a CD-ROM drive, a DVD drive, or other suitable removable or non-removable storage units. Memory unit 144 and/or storage unit 146, for example, may store data processed by wireless communication devices 102 and/or 104.

In some demonstrative embodiments, wireless communication devices 102 and 104 may include, or may be associated with, one or more antennas 106 and 108, respectively. Antennas 106 and/or 108 may include any type of antennas suitable for transmitting and/or receiving wireless communication signals, blocks, frames, transmission streams, packets, messages and/or data, e.g., over wireless medium 110. For example, antennas 106 and/or 108 may include any suitable configuration, structure and/or arrangement of one or more antenna elements, components, units, assemblies and/or arrays. Antennas 106 and/or 108 may include an antenna covered by a quasi-omni antenna pattern. For example, antennas 106 and/or 108 may include at least one of a phased array antenna, a single element antenna, a set of switched beam antennas, and the like. In some embodiments, antennas 106 and/or 108 may implement transmit and receive functionalities using separate transmit and receive antenna elements. In some embodiments, antennas 106 and/or 108 may implement transmit and receive functionalities using common and/or integrated transmit/receive elements.

In some demonstrative embodiments, device 102 may retain a set of one or more connection (“network”) profiles 151 corresponding to previously connected access points (APs), e.g., including device 104.

In some demonstrative embodiments, the connection profiles 151 may be stored by memory 144 and/or storage 146 of device 106.

For example, the connection profiles 151 may include a Service Set Identifier (SSID) of one or more APs, e.g., a home AP, a work AP, a regular coffee shop AP, and/or any other AP.

In one example, connection profiles 151 may include a connection profile relating to an AP (“Office AP”) located at an office of a user of device 102, a connection profile relating to an AP (“Coffee Shop AP”) located at a coffee shop visited by the user of device 102, a connection profile relating to an AP (“Home AP”) located home of the user of device 102, and the like.

In some demonstrative embodiments, device 102 may be configured to search for at least one AP, e.g., an AP of connection profiles 151. For example, an operating System (OS) networking stack of device 102 may periodically search for the APs of connection profiled 151, for example, in order to auto-connect to any of the APs, e.g., device 104, when found.

In some cases, device 102 may perform directed scanning to scan for a particular AP, e.g., for device 104.

In some demonstrative embodiments, sending an unencrypted Probe Request frame with an SSID of the AP being searched for may create a privacy vulnerability.

For example, a malicious user may passively monitor air traffic and/or collect information about mobile devices in search of specific SSIDs. Such information may give away prior locations of the mobile devices and/or history of connections, and/or may allow clustering of mobile devices searching for the same SSID.

For example malicious user may easily identify an employee of an enterprise, away from the enterprise network, for example, by detecting mobile devices that probe for an SSID identifying the enterprise network.

In one example, the malicious user may monitor a wireless medium to receive probe requests transmitted by a plurality of mobile devices. The malicious user may detect probe requests including the same SSID, e.g., an SSID “Primary WLAN XXX”, wherein XXX denotes a name of an enterprise. The malicious user may use the detected probe requests to cluster the mobile devices as belonging to users of the enterprise XXX.

Such vulnerability may be manifested in situations where the user of the mobile device is physically away from the physical location of the network being searched for. For example, in a situation where the user is physically near the network being searched, a malicious listener would have to be physically located near the network as well, hence physically associating the user to the network.

In one example, a malicious user may be located at a location, e.g., a public location, which may be unrelated to and/or distant from a location of the enterprise “XXX”. However, if device 102 is to transmit probe requests including the SSID “Primary WLAN XXX”, the malicious user may detect the probe requests and may identify a relationship between the device 102 and the enterprise “XXX”.

In some demonstrative embodiments, applying a network cloaking mechanism may escalate the issue of the vulnerability of information included in the probe requests to malicious use.

For example, the network cloaking mechanism may “hide” the SSID of the AP by not allowing the AP to publically broadcast the SSID of the AP. However, the network cloaking mechanism may require device 102 to send the directed probe request with the SSID of the AP in order to discover the AP.

In some demonstrative embodiments, device 102 and/or 104 may be configured to enable device 102 to scan for an AP, e.g., device 104, using an obfuscated network identifier, e.g., different from an actual network identifier of the AP being search for.

In some demonstrative embodiments, device 102 and/or 104 may be configured to enable device 102 to scan for an AP, e.g., device 104, using an obfuscated SSID, e.g., different from an actual SSID of the AP being search for.

Some embodiments are described below with respect to using an obfuscated SSID. However in other embodiments, device 102 may be configured to scan for an AP, e.g., device 104, using any other obfuscated network identifier.

In some demonstrative embodiments, the obfuscated SSID may be configured to disable a malicious passive monitor to identify a connection history of the device 102 and/or to cluster mobile devices that search for the same SSID.

In some demonstrative embodiments, transmitter 191 may search for device 104 by sending a probe request, e.g., an unauthenticated and/or directed probe request, including an obfuscated SSID, which is different from an actual SSID of device 104.

In some demonstrative embodiments, device 102 may include an SSID obfuscation module 125 to determine the obfuscated SSID to be included in the probe request to device 104, e.g., as described below.

In some demonstrative embodiments, the functionality of SSID obfuscation module 125 may be implemented as part of controller 123. In other embodiments, SSID obfuscation module 125 may be implemented as a separate element and/or as part of any other element of wireless communication unit 120 and/or any other element of wireless communication device 102.

In some demonstrative embodiments, the obfuscated SSID may include a unique obfuscated SSID, e.g., which may be unique to device 102. For example, the obfuscated SSID utilized by device 102 to search for device 104 may be different from other, e.g., any other, obfuscated SSIDs utilized by other devices, e.g., a device 103, to search for device 104.

For example, device 102 may transmit a probe request including a first obfuscated SSID corresponding to the actual SSID of device 104, and device 103 may transmit a probe request including a second obfuscated SSID, different from the first obfuscated SSID, corresponding to the actual SSID of device 104.

In some demonstrative embodiments, utilizing different, e.g., unique, obfuscated SSIDs, by different devices, to search for the same AP, may enable to decrease the ability of a malicious listener to connect between the different devices and the AP, to identify the AP, and/or to cluster the different devices.

In some demonstrative embodiments, the obfuscated SSID used by device 102 may be configured as to not identify the actual SSID of device 104, e.g., to a malicious user, which may detect the probe request.

In some demonstrative embodiments, receiver 194 may receive the probe request from device 102, e.g., when device 102 is within range of device 104.

In some demonstrative embodiments, device 104 may be configured to support the SSID obfuscation. For example, wireless communication device 104 may be configured to determine that the obfuscated SSID from device 102 is to identify device 104, e.g., as described below.

In some demonstrative embodiments, wireless communication device 104 may include an SSID validation module 135 to validate the obfuscated SSID of the probe request with respect to the actual SSID of device 104, e.g., as described below.

In some demonstrative embodiments, the functionality of SSID validation module 135 may be implemented as part of controller 133. In other embodiments, SSID validation module 135 may be implemented as a separate element and/or as part of any other element of wireless communication unit 130 and/or any other element of wireless communication device 104.

In some demonstrative embodiments, transmitter 193 may transmit to device 102 a probe response in response to the probe request, e.g., if SSID validation module 135 is to determine that the obfuscated SSID corresponds to the actual SSID of device 104.

In some demonstrative embodiments, further obfuscation and/or encryption of the actual SSID of device 104 may not be required, for example, when the actual SSID is communicated by device 104, e.g., as part of the probe response.

For example, the obfuscation of the SSID of device 104 may be configured to disable disclosure of the actual SSID of device 104 in a situation, when the device 102 is physically away from the physical location of the network of device 104, e.g., as discussed above. Therefore, device 104 may not receive the probe request from device 102, when the device 102 is physically away from the network of device 104. Accordingly, no response is to be communicated by device 104, in response to the probe request, for example, when the device 102 is physically away from the network of device 104.

In some demonstrative embodiments, transmitter 193 may transmit the probe response including the actual SSID of device 104. In other embodiments, the probe response may include another SSID, e.g., the obfuscated SSID or another obfuscated SSID.

In some demonstrative embodiments, receiver 194 may receive probe requests including different obfuscated SSIDs from tow or more mobile devices.

For example, receiver 194 may receive a first probe request from a first mobile device, e.g., device 102, and a second probe request from a second mobile device, e.g., device 103. The first probe request may include a first obfuscated SSID. The second probe request may include a second obfuscated SSID, which may be different from the first obfuscated SSID. For example, the first obfuscated SSID may be unique to device 102, and the second obfuscated SSID may be unique to device 103, e.g., as described above.

In some demonstrative embodiments, SSID validation module 135 may validate the first obfuscated SSID as corresponding to the actual SSID of device 104, e.g., as described below. SSID validation module 135 may validate the second obfuscated SSID as corresponding to the actual SSID of device 104, e.g., as described below.

In some demonstrative embodiments, transmitter 193 may transmit to the first mobile device, e.g., to device 102, a first probe response including the actual SSID of device 104, e.g., in response to the first probe request. Transmitter 193 may transmit to the second mobile device, e.g., to device 103, a second probe response including the actual SSID of device 104, e.g., in response to the second probe request.

In other embodiments, transmitter 193 may transmit the probe responses including any other SSID, e.g., the first and second obfuscated SSIDs and/or any other obfuscated SSID.

In some demonstrative embodiments, the obfuscated SSID may include an encrypted SSID based on the actual SSID of device 104, e.g., as described below.

In some demonstrative embodiments, the obfuscated SSID may include any preset obfuscated SSID, which may be preset and/or negotiated by wireless communication units 120 and 130, e.g., as described below.

In some demonstrative embodiments, SSID obfuscation module 125 may determine an obfuscated SSID corresponding to an AP to be scanned for. For example, SSID obfuscation module 125 may determine an obfuscated SSID corresponding to device 104, e.g., if device 104 is to be scanned for.

In some demonstrative embodiments, SSID obfuscation module 125 may determine the obfuscated SSID by obfuscating or encrypting the actual SSID of the AP to be scanned for. For example, SSID obfuscation module 125 may determine the obfuscated SSID corresponding to device 104 by obfuscating or encrypting the actual SSID of device 104.

In some demonstrative embodiments, SSID obfuscation module 125 may determine the obfuscated SSID corresponding to device 104 based on a predefined key (“secret”) 127.

In some demonstrative embodiments, the key 127 may include a unique key, which may be defined for device 102, e.g., independently of other keys defined for other devices. For example, key 127 may be stored at memory 144 and/or storage 146.

In some demonstrative embodiments, SSID obfuscation module 125 may determine the obfuscated SSID corresponding to the AP to be scanned for based on a hash of the actual SSID of the AP and the key 127.

In some demonstrative embodiments, connection profile 151 may include one or more actual SSIDs 153 of one or more APs, e.g., including an actual SSID of device 104.

In some demonstrative embodiments, SSID obfuscation module 125 may determine the obfuscated SSID corresponding to the AP to be scanned for by hashing the actual SSID 153 of the AP with the key 127.

In some demonstrative embodiments, key 127 may be, for example, pre-installed at device 102 and/or device 104, for example, as part of a connection profile 151.

In some demonstrative embodiments, key 127 may be communicated between device 102 and device 104, for example, as part of a connection, e.g., upon a first connection, between device 102 and device 104, e.g., when device 102 is physically located in proximity to device 104.

In some demonstrative embodiments, the actual SSID of device 104 may include a character code, for example, a string of characters, e.g., a string of American Standard Code for Information Interchange (ASCII) characters. In one example, the actual SSID of device 104 may include the string “Primary WLAN XXX” or any other string, e.g., as described above.

In some demonstrative embodiments, generating the obfuscated SSID by hashing the actual SSID may result in the obfuscated SSID including a binary code, e.g., a string of bits having the value “0” or “1”.

In some demonstrative embodiments, the binary SSID may be different from the actual SSID string in a way, which may not enable a malicious user to identify the actual SSID based on the obfuscated SSID.

In some demonstrative embodiments, the obfuscated SSID may not enable a malicious user to obtain from the probe request useful information regarding device 102 and/or device 104 and/or a connection between devices 102 and 104 and/or between device 102 and one or more other devices, e.g., device 103.

In some demonstrative embodiments, SSID obfuscation module 125 may be configured to generate the obfuscated SSID, in a form, which may enable SSID validation module 135 to validate the obfuscated SSID as corresponding to the actual SSID of device 104, e.g., on the fly.

In some demonstrative embodiments, SSID validation module 135 may determine a key to be used to de-obfuscate an obfuscated SSID received in a probe request from a mobile device, for example, based on a media-access-control (MAC) address of the mobile device, or any other attribute identifying the mobile device, which may be included, for example, as part of the probe request.

In some demonstrative embodiments, device 104 may store a plurality of keys corresponding to a plurality of mobile devices, e.g., in memory 144 and/or storage 146 of device 104.

In one example, device 104 may store a different key for each mobile device.

In another example, device 104 may store a group key corresponding to a group of mobile devices, SSID validation module 135 may determine a particular key corresponding to a particular mobile device based on the group key and an identifier of the mobile device, e.g., the MAC address of the mobile device. For example, SSID validation module 135 may determine the particular key corresponding to the particular mobile device based on combination, e.g., a concatenation, hashing and/or any other function, of the group key and the identifier of the mobile device.

In some demonstrative embodiments, device 104 may receive from device 102 the probe request including the obfuscated SSID, and SSID validation module 135 may use the MAC address of device 102, e.g., which may be received as part of the probe request, to determine the key to be used to validate the obfuscated SSID.

In some demonstrative embodiments, SSID validation module 135 may validate the obfuscated SSID, for example, by performing a hash using the actual own SSID of device 104 and the key corresponding to the device 102. For example, SSID validation module 135 may validate the obfuscated SSID if the result of the hash matches the received obfuscated SSID.

In some demonstrative embodiments, a malicious user or attacker may not be able to de-obfuscate the obfuscated SSID, e.g., without knowing the key used to hash the obfuscated SSID, for example, since the Hash algorithm is non-reversible.

In other embodiments, the obfuscated SSID used by device 102 may be determined in any other manner, e.g., as described below.

In some demonstrative embodiments, the obfuscated SSID may be preset at device 102, for example, as part of a preset communication profile, e.g., which may be preset for example, by an administrator or an Information Technology (IT) manager. For example, an obfuscated SSID 154 may be pr-stored as part of connection profile 151. The obfuscated SSID 154 corresponding to an AP, e.g., the obfuscated SSID corresponding to device 104, may be associated, for example, with the actual SSID 153 of the AP.

In one example, radio 121 may scan for device 104, e.g., according to a network profile 151 corresponding to device 104. According to this example, SSID obfuscation module 125 may retrieve obfuscated SSID 154 from a network profile 151 corresponding to device 104, and transmitter 191 may transmit a probe request including the retrieved obfuscated SSID 154.

In some demonstrative embodiments, for a given network, a different unique obfuscated SSID may be configured in the profile installed in each mobile device. For example, device 102 may have a first preset obfuscated SSID 154 corresponding to device 104, and device 103 may have a second preset obfuscated SSID 154 corresponding to device 104. The first and second preset obfuscated SSIDs 154 may include different and unique obfuscated SSIDs.

In some demonstrative embodiments, devices 102 and/or 104 may be configured to apply an SSID filtering mechanism. For example, the SSID filtering mechanism may be configured to enable to achieve fast connection setup, e.g., by enabling device 102 to search a pattern to match a specific group of networks, e.g., including the network of device 104.

In some demonstrative embodiments, SSID obfuscation module 125 may determine an obfuscated filter SSID representing a plurality of SSIDs, e.g., as described below.

In some demonstrative embodiments, wireless communication device 102 may search for an SSID pattern including “wildcards”, which may enable searching for a plurality of networks. For example, wireless communication unit 120 may search for the pattern “*ABCDE*”, e.g., to search for all networks having an SSID including the string “ABCDE”.

In some demonstrative embodiments, SSID obfuscation module 125 may determine an obfuscated filter SSID representing the SSID pattern.

In some demonstrative embodiments, SSID obfuscation module 125 may determine the obfuscated filter SSID, for example, by obfuscating the SSID pattern.

In one example, SSID obfuscation module 125 may determine the obfuscated filter SSID by hashing the SSID pattern with the key 127, e.g., as described above.

In some demonstrative embodiments, transmitter 191 may transmit a probe request including the obfuscated filter SSID. Receiver 194 may receive the probe request, and SSID validation module 135 may de-obfuscate the obfuscated filter SSID, e.g., to determine whether the SSID pattern includes the actual SSID of device 104. Wireless communication device 104 may respond to the probe request with a probe response, e.g., if the whether the SSID pattern includes the actual SSID of device 104.

In some demonstrative embodiments, using the obfuscated SSID may enable device 102, for example, to utilize the SSID filtering mechanism, e.g., while avoiding exposure of the network connection preferences of device 102.

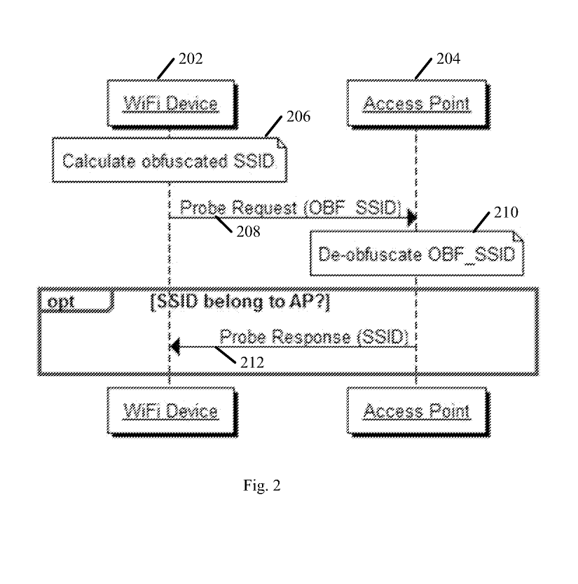

Reference is made to FIG. 2, which schematically illustrates a sequence of operations and communications between a mobile device (denoted “WiFi device”) 202 and an access point 204, in accordance with some demonstrative embodiments. For example, device 102 (FIG. 1), wireless communication unit 120 (FIG. 1), radio 121 (FIG. 1), transmitter 191 (FIG. 1), receiver 192 (FIG. 1), controller 123 (FIG. 1) and/or SSID obfuscation module 125 (FIG. 1) may perform the functionality of mobile device 202; and/or device 104 (FIG. 1), wireless communication unit 130 (FIG. 1) radio 131 (FIG. 1), transmitter 193 (FIG. 1), receiver 194 (FIG. 1), controller 133 (FIG. 1) and/or SSID validation module 135 (FIG. 1) may perform the functionality of access point 204.

In some demonstrative embodiments, mobile device 202 may select to scan for AP 204.

In some demonstrative embodiments, mobile device 202 may determine obfuscated SSID 206, denoted OBF_SSID, corresponding to AP 204. For example, SSID obfuscation module 125 (FIG. 1) may determine the obfuscated SSID 206, e.g., as described above.

In some demonstrative embodiments, the obfuscated SSID 206 may be configured to enable AP 204 to validate the obfuscated SSID 206 as corresponding to the actual SSID of AP 204, e.g., on the fly.

In some demonstrative embodiments, mobile device 202 may determine the obfuscated SSID 206 by obfuscating or encrypting the actual SSID of AP 204.

In one example, mobile device 202 may determine the obfuscated SSID by hashing the actual SSID of AP 204 with a predefined key, for example, key 127 (FIG. 1), which may be uniquely assigned to mobile device 202, e.g., as described above.

In some demonstrative embodiments, mobile device 202 may scan for AP 204 by transmitting a probe request 208, e.g., a direct unencrypted scan request, including the obfuscated SSID 206.

In some demonstrative embodiments, the obfuscated SSID 206 may be different from the actual SSID of AP 204 in a way, which may not enable a malicious user to identify the actual SSID of AP 204 based on the obfuscated SSID 206, e.g., as described above.

In some demonstrative embodiments, probe request 208 may not be received by AP 204, for example, when mobile device 202 is physically located without a coverage area of AP 204. According to these embodiments, mobile device 202 may not receive a response to probe request 208, for example, when mobile device 202 is physically located without the coverage area of AP 204.

In some demonstrative embodiments, a malicious user or attacker may not be able to de-obfuscate the obfuscated SSID 206, e.g., without knowing the key used to hash the obfuscated SSID 206.

In some demonstrative embodiments, AP 204 may receive the probe request 208 including the obfuscated SSID 206, for example, when mobile device 202 is physically located within the coverage area of AP 204.

In some demonstrative embodiments, AP 204 may de-obfuscate 210 the obfuscated SSID 208. For example, SSID validation module 135 (FIG. 1) may de-obfuscate the obfuscated SSID 208, e.g., as described above.

In some demonstrative embodiments, AP 204 may validate the de-obfuscated SSID 206 as corresponding to the own actual SSID of AP 204. For example, SSID validation module 135 (FIG. 1) may validate the de-obfuscated SSID, e.g., as described above.

In some demonstrative embodiments, AP 204 may optionally send to mobile device 202 a probe response 212, in response to probe request 208. In other embodiments, AP 204 may select not to send probe response, e.g., if a communication protocol does not require sending a probe response.

In some demonstrative embodiments, the probe response 212 may include the actual SSID of AP 204.

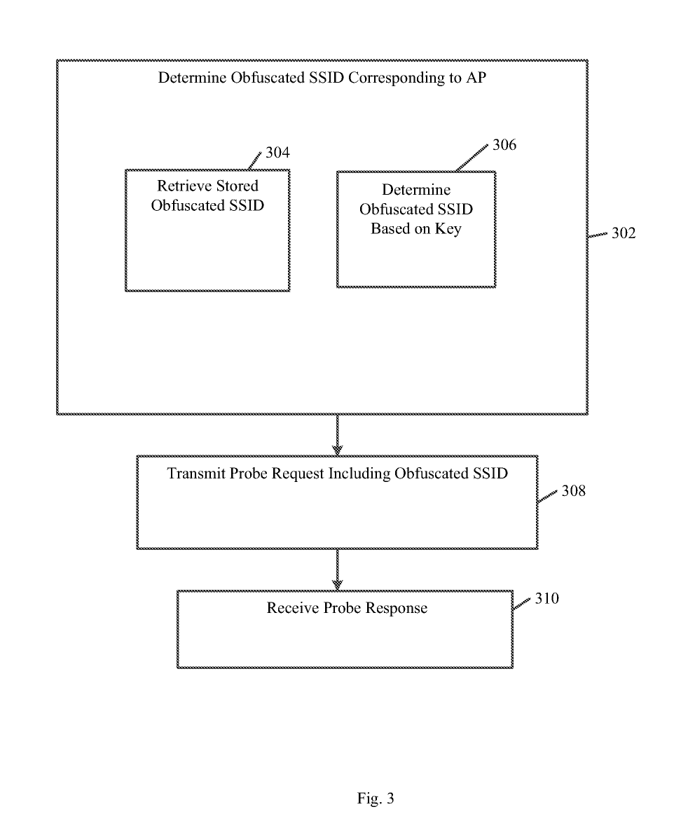

Reference is made to FIG. 3, which schematically illustrates a method of obfuscating a wireless communication network identifier, in accordance with some demonstrative embodiments. In some demonstrative embodiments, one or more of the operations of the method of FIG. 3 may be performed by a mobile device, e.g., device 102 (FIG. 1), to scan for an AP, e.g., device 104 (FIG. 1).

As indicated at block 302, the method may include determining an obfuscated network identifier corresponding to the AP. For example, SSID obfuscation module 125 (FIG. 1) may determine an obfuscated SSID corresponding to device 104 (FIG. 1), e.g., as described above.

As indicated at block 304, determining the obfuscated network identifier may include retrieving a stored obfuscated network identifier corresponding to the AP. For example, SSID obfuscation module 125 (FIG. 1) may retrieve the obfuscated SSID 154 (FIG. 1) corresponding to device 104 (FIG. 1), for example, from network profile 151 (FIG. 1), e.g., as described above.

As indicated at block 306, determining the obfuscated network identifier may include determining the obfuscated network identifier based on a key. For example, SSID obfuscation module 125 (FIG. 1) may determine the obfuscated SSID based on key 127 (FIG. 1), for example, by hashing the actual 153 SSID (FIG. 1) corresponding to device 104 (FIG. 1) with key 127 (FIG. 1), e.g., as described above.

As indicated at block 308, the method may include transmitting a probe request including the obfuscated network identifier. For example, transmitter 191 (FIG. 1) may transmit the probe request including the obfuscated SSID corresponding to device 104 (FIG. 1), e.g., as described above.

As indicated at block 310, the method may include receiving a probe response, e.g., in response to the probe request. For example, the probe response may be received, when the mobile device is physically located within a coverage range of the AP. The probe response may not be received, for example, when the mobile device is physically located outside of the coverage range of the AP. For example, device 102 (FIG. 1) may receive a probe response from device 104 (FIG. 1), in response to the probe request, e.g., as described above.

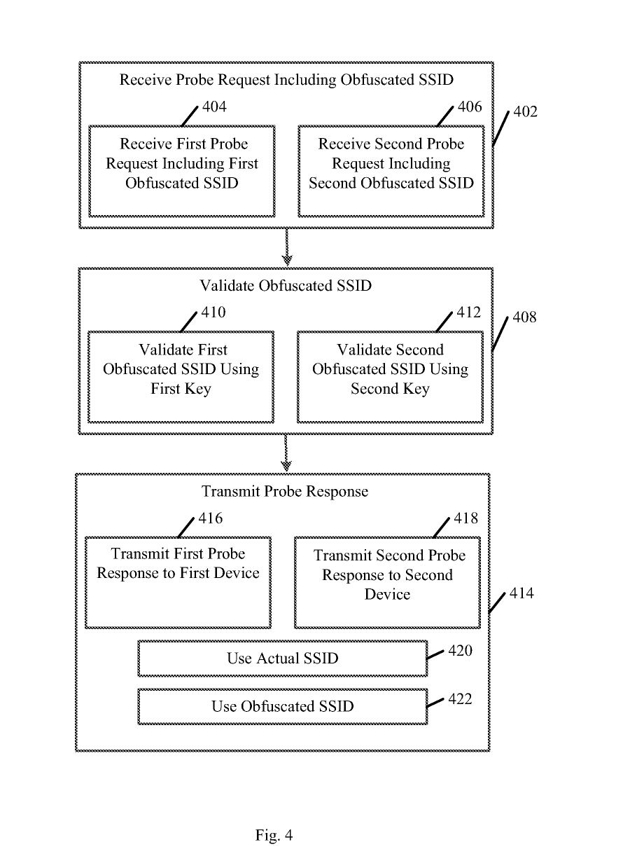

Reference is made to FIG. 4, which schematically illustrates a method of processing an obfuscated wireless communication network identifier, in accordance with some demonstrative embodiments. In some demonstrative embodiments, one or more of the operations of the method of FIG. 4 may be performed by an AP, e.g., device 104 (FIG. 1) to process a network identifier received from a mobile device, e.g., device 102 (FIG. 1).

As indicated at block 402, the method may include receiving a probe request including an obfuscated network identifier.

As indicated at block 404, receiving the probe request may include receiving from a first mobile device a first probe request including a first obfuscated network identifier. For example, device 104 (FIG. 1) may receive from device 102 (FIG. 1) a first probe request including a first obfuscated SSID, e.g., as described above.

As indicated at block 406, receiving the probe request may include receiving from a second mobile device a second probe request including a second obfuscated network identifier. For example, device 104 (FIG. 1) may receive from device 103 (FIG. 1) a second probe request including a second obfuscated SSID, e.g., as described above.

In some demonstrative embodiments, the first obfuscated network identifier may be different from the second obfuscated network identifier. For example, the first obfuscated SSID may be unique to device 102 (FIG. 1) and the second obfuscated SSID may be unique to device 103 (FIG. 1), e.g., as described above.

As indicated at block 408, the method may include validating the obfuscated network identifier.

As indicated at block 410, validating the obfuscated network identifier may include validating the first obfuscated network identifier using a first key. For example, SSID validation module 135 (FIG. 1) may validate the first obfuscated SSID using a key corresponding to device 102 (FIG. 1), for example, by hashing the actual SSID of device 104 (FIG. 1) with the key corresponding to device 102 (FIG. 1), e.g., as described above.

As indicated at block 412, validating the obfuscated network identifier may include validating the second obfuscated network identifier using a second key. For example, SSID validation module 135 (FIG. 1) may validate the second obfuscated SSID using a key corresponding to device 103 (FIG. 1), for example, by hashing the actual SSID of device 104 (FIG. 1) with the key corresponding to device 103 (FIG. 1), e.g., as described above.

As indicated at block 414, the method may include transmitting a probe response, e.g., if the obfuscated network identifier is determined to be valid.

As indicated at block 416, transmitting the probe response may include transmitting a first probe response to the first mobile device. For example, transmitter 193 (FIG. 1) may transmit the first probe response to device 102 (FIG. 1), for example, if the first obfuscated SSID is determined to be valid, e.g., as described above.

As indicated at block 418, transmitting the probe response may include transmitting a second probe response to the second mobile device. For example, transmitter 193 (FIG. 1) may transmit the second probe response to device 103 (FIG. 1), for example, if the second obfuscated SSID is determined to be valid, e.g., as described above.

As indicated at block 420, transmitting the probe response may include transmitting the probe response including an actual network identifier of the AP. For example, transmitter 193 (FIG. 1) may transmit the first probe response and/or the second probe response including the actual SSID of device 104 (FIG. 1), e.g., as described above.

As indicated at block 422, transmitting the probe response may include transmitting the probe response including the obfuscated network identifier. For example, transmitter 193 (FIG. 1) may transmit the first probe response including the first obfuscated SSID, and/or the second probe response including the second obfuscated SSID, e.g., as described above.

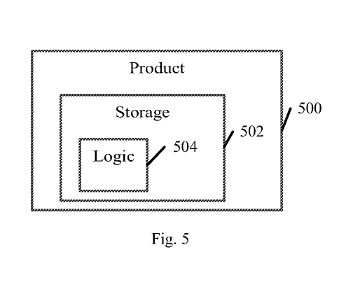

Reference is made to FIG. 5, which schematically illustrates a product of manufacture 500, in accordance with some demonstrative embodiments. Product 500 may include one or more tangible non-transitory machine-readable storage media 502 to store logic 504, which may be used, for example, to perform at least part of the functionality of devices 102 and/or 104 (FIG. 1), wireless communication units 120 and/or 130 (FIG. 1), Radios 121 and/or 131 (FIG. 1), SSID obfuscation module 125 (FIG. 1), controller 123 (FIG. 1), SSID validation module 135 (FIG. 1), controller 133 (FIG. 1), mobile device 202 (FIG. 2), AP 204 (FIG. 2), and/or to perform one or more of the operations of the method of FIG. 3 and/or FIG. 4. The phrase “non-transitory machine-readable medium” is directed to include all computer-readable media, with the sole exception being a transitory propagating signal.

In some demonstrative embodiments, product 500 and/or machine-readable storage media 502 may include one or more types of computer-readable storage media capable of storing data, including volatile memory, non-volatile memory, removable or non-removable memory, erasable or non-erasable memory, writeable or rewriteable memory, and the like. For example, machine-readable storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes a wireless communication unit comprising a receiver; and a transmitter to scan for an access point (AP) by transmitting a probe request including an obfuscated service set identifier (SSID), the obfuscated SSID being different from an actual SSID of the AP.

Example 2 includes the subject matter of Example 1, and optionally, receiver is to receive from the AP a probe response in response to the probe request, the probe response including the actual SSID of the AP.

Example 3 includes the subject matter of Example 1 or 2, and optionally, wherein the obfuscated SSID is unique to the wireless communication unit.

Example 4 includes the subject matter of any one of Examples 1-3, and optionally, wherein the obfuscated SSID does not identify the actual SSID of the AP.

Example 5 includes the subject matter of any one of Examples 1-4, and optionally, wherein the obfuscated SSID is based on a predefined key.

Example 6 includes the subject matter of Example 5, and optionally, wherein the obfuscated SSID comprises a hash of the actual SSID and the predefined key.

Example 7 includes the subject matter of Example 5 or 6, and optionally, wherein the predefined key comprises a unique key assigned to the wireless communication unit.

Example 8 includes the subject matter of any one of Examples 5-7, and optionally, wherein the wireless communication unit is to communicate the predefined key with the AP.

Example 9 includes the subject matter of any one of Examples 1-8, and optionally, wherein the wireless communication unit is to retrieve the obfuscated SSID from a network profile corresponding to the AP.

Example 10 includes the subject matter of any one of Examples 1-9, and optionally, wherein the obfuscated SSID comprises an obfuscated filter SSID representing a plurality of SSIDs.

Example 11 includes the subject matter of any one of Examples 1-10, and optionally, wherein the obfuscated SSID comprises a binary code, and wherein the actual SSID comprises a character code.

Example 12 includes an apparatus of wireless communication, the apparatus comprising a wireless communication unit to receive at an access point (AP) a probe request from a mobile device, and to transmit to the mobile device a probe response in response to the probe request, the probe request including an obfuscated service set identifier (SSID), the obfuscated SSID being different from an actual SSID of the AP.

Example 13 includes the subject matter of Example 12, and optionally, wherein the probe response includes the actual SSID of the AP.

Example 14 includes the subject matter of Example 12 or 13, and optionally, wherein the wireless communication unit is to receive a first probe request from a first mobile device and a second probe request from a second mobile device, the first probe request including a first obfuscated SSID, and the second probe request including a second obfuscated SSID different from the first obfuscated SSID.

Example 15 includes the subject matter of Example 14, and optionally, wherein the wireless communication unit is to transmit to the first mobile device a first probe response including the actual SSID, and to transmit to the second mobile device a second probe response including the actual SSID.

Example 16 includes the subject matter of any one of Examples 12-15, and optionally, wherein the obfuscated SSID comprises a unique obfuscated SSID, which is unique to the mobile device.

Example 17 includes the subject matter of any one of Examples 12-16, and optionally, wherein the obfuscated SSID does not identify the actual SSID.

Example 18 includes the subject matter of any one of Examples 12-17, and optionally, wherein the obfuscated SSID is based on a predefined key.

Example 19 includes the subject matter of Example 18, and optionally, wherein the obfuscated SSID comprises a hash of the actual SSID and the predefined key.

Example 20 includes the subject matter of Example 18 or 19, and optionally, wherein the predefined key comprises a unique key assigned to the mobile device.

Example 21 includes the subject matter of any one of Examples 18-20, and optionally, wherein the wireless communication unit is to communicate the predefined key with the mobile device.

Example 22 includes the subject matter of any one of Examples 18-20, and optionally, wherein the wireless communication unit is to determine the predefined key based on a media-access-control (MAC) address of the mobile device.

Example 23 includes the subject matter of any one of Examples 18-20, and optionally, wherein the wireless communication unit is to retrieve the predefined key from a plurality of stored keys based on a media-access-control (MAC) address of the mobile device.

Example 24 includes the subject matter of any one of Examples 12-23, and optionally, wherein the obfuscated SSID comprises an obfuscated filter SSID representing a plurality of SSIDs.

Example 25 includes the subject matter of any one of Examples 12-24, and optionally, wherein the obfuscated SSID comprises a binary code, and wherein the actual SSID comprises a character code.

Example 26 includes a mobile device comprising a processor; a memory; at least one antenna; and a radio including a transmitter and a receiver, the transmitter to scan for an access point (AP) by transmitting a probe request including an obfuscated service set identifier (SSID), the obfuscated SSID being different from an actual SSID of the AP.

Example 27 includes the subject matter of Example 26, and optionally, wherein the receiver is to receive from the AP a probe response in response to the probe request, the probe response including the actual SSID of the AP.

Example 28 includes the subject matter of Example 26 or 27, and optionally, wherein the obfuscated SSID is unique to the mobile device.

Example 29 includes the subject matter of any one of Examples 26-28, and optionally, wherein the obfuscated SSID does not identify the actual SSID of the AP.

Example 30 includes the subject matter of any one of Examples 26-29, and optionally, wherein the obfuscated SSID is based on a predefined key.

Example 31 includes the subject matter of Example 30, and optionally, wherein the obfuscated SSID comprises a hash of the actual SSID and the predefined key.

Example 32 includes the subject matter of Example 30 or 31, and optionally, wherein the predefined key comprises a unique key assigned to the mobile device.

Example 33 includes the subject matter of any one of Examples 30-32, and optionally, wherein the radio is to communicate the predefined key with the AP.

Example 34 includes the subject matter of any one of Examples 26-33, and optionally, wherein the mobile device is to retrieve the obfuscated SSID from a network profile corresponding to the AP.

Example 35 includes the subject matter of any one of Examples 26-34, and optionally, wherein the obfuscated SSID comprises an obfuscated filter SSID representing a plurality of SSIDs.

Example 36 includes the subject matter of any one of Examples 26-35, and optionally, wherein the obfuscated SSID comprises a binary code, and wherein the actual SSID comprises a character code.

Example 37 includes an access point (AP) comprising at least one antenna; a memory; a processor; and a radio including a transmitter and a receiver, the receiver to receive a probe request from a mobile device, and the transmitter to transmit to the mobile device a probe response in response to the probe request, the probe request including an obfuscated service set identifier (SSID), the obfuscated SSID being different from an actual SSID of the AP.

Example 38 includes the subject matter of Example 37, and optionally, wherein the probe response includes the actual SSID of the AP.

Example 39 includes the subject matter of Example 37 or 38, and optionally, wherein the receiver is to receive a first probe request from a first mobile device and a second probe request from a second mobile device, the first probe request including a first obfuscated SSID, and the second probe request including a second obfuscated SSID different from the first obfuscated SSID.

Example 40 includes the subject matter of Example 39, and optionally, wherein the transmitter is to transmit to the first mobile device a first probe response including the actual SSID, and to transmit to the second mobile device a second probe response including the actual SSID.

Example 41 includes the subject matter of any one of Examples 37-40, and optionally, wherein the obfuscated SSID is unique to the mobile device.

Example 42 includes the subject matter of any one of Examples 37-41, and optionally, wherein the obfuscated SSID does not identify the actual SSID.

Example 43 includes the subject matter of any one of Examples 37-42, and optionally, wherein the obfuscated SSID is based on a predefined key.

Example 44 includes the subject matter of Example 43, and optionally, wherein the obfuscated SSID comprises a hash of the actual SSID and the predefined key.

Example 45 includes the subject matter of Example 43 or 44, and optionally, wherein the predefined key comprises a unique key assigned to the mobile device.

Example 46 includes the subject matter of any one of Examples 43-45, and optionally, wherein the radio is to communicate the predefined key with the mobile device.

Example 47 includes the subject matter of Example 43, and optionally, comprising an SSID validation module to determine the predefined key based on a media-access-control (MAC) address of the mobile device.

Example 48 includes the subject matter of Example 43, and optionally, comprising an SSID validation module to retrieve the predefined key from a plurality of stored keys based on a media-access-control (MAC) address of the mobile device.

Example 49 includes the subject matter of any one of Examples 37-48, and optionally, wherein the obfuscated SSID comprises an obfuscated filter SSID representing a plurality of SSIDs.

Example 50 includes the subject matter of any one of Examples 37-49, and optionally, wherein the obfuscated SSID comprises a binary code, and wherein the actual SSID comprises a character code.

Example 51 includes a method performed at a mobile device or an access point, the method comprising communicating a probe request, the probe request from the mobile device to the access point, the probe request including an obfuscated service set identifier (SSID), which is different from an actual SSID of the AP.

Example 52 includes the subject matter of Example 51, and optionally, comprising communicating a probe response in response to the probe request, the probe response from the AP to the mobile device, the probe response including the actual SSID of the AP.

Example 53 includes the subject matter of Example 51 or 52, and optionally, wherein the obfuscated SSID comprises a unique obfuscated SSID, which is unique to the mobile device.

Example 54 includes the subject matter of any one of Examples 51-53, and optionally, wherein the obfuscated SSID does not identify the actual SSID of the AP.

Example 55 includes the subject matter of any one of Examples 51-54, and optionally, wherein the obfuscated SSID is based on a predefined key.

Example 56 includes the subject matter of Example 55, and optionally, wherein the obfuscated SSID comprises a hash of the actual SSID and the predefined key.

Example 57 includes the subject matter of Example 55 or 56, and optionally, wherein the predefined key comprises a unique key assigned to the mobile device.

Example 58 includes the subject matter of any one of Examples 55-57, and optionally, comprising communicating the predefined key between the mobile device and the AP.

Example 59 includes the subject matter of any one of Examples 51-58, and optionally, wherein the obfuscated SSID comprises an obfuscated filter SSID representing a plurality of SSIDs.

Example 60 includes the subject matter of any one of Examples 51-59, and optionally, wherein the obfuscated SSID comprises a binary code, and wherein the actual SSID comprises a character code.

Example 61 includes the subject matter of any one of Examples 51-60, and optionally, wherein the communicating comprises transmitting the probe request from the mobile device.

Example 62 includes the subject matter of Example 61, and optionally, comprising retrieving the obfuscated SSID from a network profile corresponding to the AP.

Example 63 includes the subject matter of any one of Examples 51-60, and optionally, wherein the communicating comprises receiving the probe request at the AP.

Example 64 includes the subject matter of Example 63, and optionally, comprising receiving a first probe request from a first mobile device, the first probe request including a first obfuscated SSID; and receiving a second probe request from a second mobile device, the second probe request including a second obfuscated SSID different from the first obfuscated SSID.

Example 65 includes the subject matter of Example 64, and optionally, comprising transmitting to the first mobile device a first probe response including the actual SSID; and transmitting to the second mobile device a second probe response including the actual SSID.

Example 66 includes the subject matter of any one of Examples 63-65, and optionally, wherein the obfuscated SSID is based on a predefined key, the method comprising determining the predefined key based on a media-access-control (MAC) address of the mobile device.

Example 67 includes the subject matter of any one of Examples 63-65, and optionally, wherein the obfuscated SSID is based on a predefined key, the method comprising retrieving the predefined key from a plurality of stored keys based on a media-access-control (MAC) address of the mobile device.

Example 68 includes a product including one or more tangible computer readable non-transitory storage media comprising computer-executable instructions operable to, when executed by at least one computer processor, enable the at least one computer processor to implement a method comprising at a mobile device or an access point, communicating a probe request, the probe request being from the mobile device to the access point, the probe request including an obfuscated service set identifier (SSID), which is different from an actual SSID of the AP.

Example 69 includes the subject matter of Example 68, and optionally, wherein the instructions result in communicating a probe response in response to the probe request, the probe response from the AP to the mobile device, the probe response including the actual SSID of the AP.

Example 70 includes the subject matter of Example 68 or 69, and optionally, wherein the obfuscated SSID comprises a unique obfuscated SSID, which is unique to the mobile device.

Example 71 includes the subject matter of any one of Examples 68-70, and optionally, wherein the obfuscated SSID does not identify the actual SSID of the AP.

Example 72 includes the subject matter of any one of Examples 68-71, and optionally, wherein the obfuscated SSID is based on a predefined key.

Example 73 includes the subject matter of Example 72, and optionally, wherein the obfuscated SSID comprises a hash of the actual SSID and the predefined key.

Example 74 includes the subject matter of Example 72 or 73, and optionally, wherein the predefined key comprises a unique key assigned to the mobile device.

Example 75 includes the subject matter of any one of Examples 72-74, and optionally, wherein the instructions result in communicating the predefined key between the mobile device and the AP.

Example 76 includes the subject matter of any one of Examples 68-75, and optionally, wherein the obfuscated SSID comprises an obfuscated filter SSID representing a plurality of SSIDs.

Example 77 includes the subject matter of any one of Examples 68-76, and optionally, wherein the obfuscated SSID comprises a binary code, and wherein the actual SSID comprises a character code.

Example 78 includes the subject matter of any one of Examples 68-77, and optionally, wherein the instructions result in transmitting the probe request from the mobile device.

Example 79 includes the subject matter of Example 78, and optionally, wherein the instructions result in retrieving the obfuscated SSID from a network profile corresponding to the AP.

Example 80 includes the subject matter of any one of Examples 68-77, and optionally, wherein the instructions result in receiving the probe request at the AP.

Example 81 includes the subject matter of Example 80, and optionally, wherein the instructions result in receiving a first probe request from a first mobile device, the first probe request including a first obfuscated SSID; and receiving a second probe request from a second mobile device, the second probe request including a second obfuscated SSID different from the first obfuscated SSID.

Example 82 includes the subject matter of Example 81 comprising transmitting to the first mobile device a first probe response including the actual SSID; and transmitting to the second mobile device a second probe response including the actual SSID.

Example 83 includes the subject matter of any one of Examples 80-82, and optionally, wherein the obfuscated SSID is based on a predefined key, and wherein the instructions result in determining the predefined key based on a media-access-control (MAC) address of the mobile device.

Example 84 includes the subject matter of any one of Examples 80-82, and optionally, wherein the obfuscated SSID is based on a predefined key, and wherein the instructions result in retrieving the predefined key from a plurality of stored keys based on a media-access-control (MAC) address of the mobile device.

Example 85 includes an apparatus of wireless communication, the apparatus comprising means for communicating a probe request at a mobile device or an access point, the probe request from the mobile device to the access point, the probe request including an obfuscated service set identifier (SSID), the obfuscated SSID being different from an actual SSID of the AP.

Example 86 includes the subject matter of Example 85, and optionally, comprising means for communicating a probe response in response to the probe request, the probe response from the AP to the mobile device, the probe response including the actual SSID of the AP.

Example 87 includes the subject matter of Example 85 or 86, and optionally, wherein the obfuscated SSID comprises a unique obfuscated SSID, which is unique to the mobile device.

Example 88 includes the subject matter of any one of Examples 85-87, and optionally, wherein the obfuscated SSID does not identify the actual SSID of the AP.

Example 89 includes the subject matter of any one of Examples 85-88, and optionally, wherein the obfuscated SSID is based on a predefined key.

Example 90 includes the subject matter of Example 89, and optionally, wherein the obfuscated SSID comprises a hash of the actual SSID and the predefined key.

Example 91 includes the subject matter of Example 89 or 90, and optionally, wherein the predefined key comprises a unique key assigned to the mobile device.

Example 92 includes the subject matter of any one of Examples 89-91, and optionally, comprising means for communicating the predefined key between the mobile device and the AP.

Example 93 includes the subject matter of any one of Examples 85-92, and optionally, wherein the obfuscated SSID comprises an obfuscated filter SSID representing a plurality of SSIDs.

Example 94 includes the subject matter of any one of Examples 85-93, and optionally, wherein the obfuscated SSID comprises a binary code, and wherein the actual SSID comprises a character code.

Example 95 includes the subject matter of any one of Examples 85-94, and optionally, comprising means for transmitting the probe request from the mobile device.

Example 96 includes the subject matter of Example 95, and optionally, comprising means for retrieving the obfuscated SSID from a network profile corresponding to the AP.

Example 97 includes the subject matter of any one of Examples 85-94, and optionally, comprising means for receiving the probe request at the AP.

Example 98 includes the subject matter of Example 97, and optionally, comprising means for receiving a first probe request from a first mobile device, the first probe request including a first obfuscated SSID; and receiving a second probe request from a second mobile device, the second probe request including a second obfuscated SSID different from the first obfuscated SSID.

Example 99 includes the subject matter of Example 98, and optionally, comprising means for transmitting to the first mobile device a first probe response including the actual SSID; and transmitting to the second mobile device a second probe response including the actual SSID.

Example 100 includes the subject matter of any one of Examples 97-99, and optionally, wherein the obfuscated SSID is based on a predefined key, the apparatus comprising means for determining the predefined key based on a media-access-control (MAC) address of the mobile device.

Example 101 includes the subject matter of any one of Examples 97-99, and optionally, wherein the obfuscated SSID is based on a predefined key, the apparatus comprising means for retrieving the predefined key from a plurality of stored keys based on a media-access-control (MAC) address of the mobile device.

Example 102 includes a method performed at a mobile device, the method comprising determining an obfuscated service set identifier (SSID) corresponding to an Access Point (AP), the obfuscated SSID being different from an actual SSID of the AP; and scanning for the AP by wirelessly transmitting a probe request including the obfuscated SSID.

Example 103 includes the subject matter of Example 102, and optionally, comprising receiving from the AP a probe response in response to the probe request, the probe response including the actual SSID of the AP.

Example 104 includes the subject matter of Example 102 or 103, and optionally, wherein the obfuscated SSID is unique to the mobile device.

Example 105 includes the subject matter of any one of Examples 102-104, and optionally, wherein the obfuscated SSID does not identify the actual SSID of the AP.

Example 106 includes the subject matter of any one of Examples 102-105, and optionally, wherein the obfuscated SSID is based on a predefined key.

Example 107 includes the subject matter of Example 106, and optionally, wherein the obfuscated SSID comprises a hash of the actual SSID and the predefined key.

Example 108 includes the subject matter of Example 106 or 107, and optionally, wherein the predefined key comprises a unique key assigned to the mobile device.

Example 109 includes the subject matter of any one of Examples 106-108, and optionally, comprising communicating the predefined key with the AP.

Example 110 includes the subject matter of any one of Examples 102-105, and optionally, comprising retrieving the obfuscated SSID from a network profile corresponding to the AP.

Example 111 includes the subject matter of any one of Examples 102-110, and optionally, wherein the obfuscated SSID comprises an obfuscated filter SSID representing a plurality of SSIDs.

Example 112 includes the subject matter of any one of Examples 102-111, and optionally, wherein the obfuscated SSID comprises a binary code, and wherein the actual SSID comprises a character code.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A wireless communication unit comprising:
a receiver; and
a transmitter, the transmitter to scan for an access point (AP) by transmitting a probe request including an obfuscated service set identifier (SSID), the obfuscated SSID being different from an actual SSID of said AP.

2. The wireless communication unit of claim 1, wherein said receiver is to receive from said AP a probe response in response to said probe request, said probe response including said actual SSID of said AP.

3. The wireless communication unit of claim 1, wherein said obfuscated SSID is unique to said wireless communication unit.

4. The wireless communication unit of claim 1, wherein said obfuscated SSID does not identify said actual SSID of said AP.

5. The wireless communication unit of claim 1, wherein said obfuscated SSID is based on a predefined key.

6. The wireless communication unit of claim 5, wherein said obfuscated SSID comprises a hash of said actual SSID and said predefined key.

7. The wireless communication unit of claim 5, wherein said predefined key comprises a unique key assigned to said wireless communication unit.

8. The wireless communication unit of claim 5, wherein said wireless communication unit is to communicate said predefined key with said AP.

9. The wireless communication unit of claim 1, wherein said wireless communication unit is to retrieve said obfuscated SSID from a network profile corresponding to said AP.

10. The wireless communication unit of claim 1, wherein said obfuscated SSID comprises an obfuscated filter SSID representing a plurality of SSIDs.

11. The wireless communication unit of claim 1, wherein said obfuscated SSID comprises a binary code, and wherein said actual SSID comprises a character code.

12. A mobile device including:
a processor;
a memory;
at least one antenna;
a radio including a transmitter and a receiver, the transmitter to scan for an access point (AP) by wirelessly transmitting a probe request including an obfuscated service set identifier (SSID), the obfuscated SSID being different from an actual SSID of said AP.

13. The mobile device of claim 12, wherein said receiver is to receive from said AP a probe response in response to said probe request, said probe response including said actual SSID of said AP.

14. The mobile device of claim 12, wherein said obfuscated SSID is unique to said wireless communication unit.

15. The mobile device of claim 12, wherein said obfuscated SSID is based on a predefined key.

16. The mobile device of claim 15, wherein said obfuscated SSID comprises a hash of said actual SSID and said predefined key.

17. A method performed at a mobile device, the method comprising:
determining an obfuscated service set identifier (SSID) corresponding to an Access Point (AP), the obfuscated SSID being different from an actual SSID of said AP; and
scanning for the AP by wirelessly transmitting a probe request including the obfuscated SSID.

18. The method of claim 17 comprising receiving from said AP a probe response in response to said probe request, said probe response including said actual SSID of said AP.

19. The method of claim 17 comprising retrieving said obfuscated SSID from a network profile corresponding to said AP.

20. One or more tangible computer-readable non-transitory storage media comprising computer-executable instructions operable to, when executed by at least one computer processor, enable the at least one computer processor to implement a method comprising:
at a mobile device or an access point, communicating a probe request, the probe request being from the mobile device to the access point, the probe request including an obfuscated service set identifier (SSID), which is different from an actual SSID of said AP.

21. The storage media of claim 20, wherein the instructions result in transmitting said probe request from said mobile device.

22. The storage media of claim 20, wherein the instructions result in receiving said probe request at said AP.

23. The storage media of claim 22, wherein the instructions result in:
receiving a first probe request from a first mobile device, the first probe request including a first obfuscated SSID; and
receiving a second probe request from a second mobile device, the second probe request including a second obfuscated SSID different from said first obfuscated SSID.

24. The storage media of claim 20, wherein the instructions result in communicating a probe response in response to said probe request, the probe response from the AP to the mobile device, said probe response including said actual SSID of said AP.

25. The storage media of claim 20, wherein said obfuscated SSID comprises a unique obfuscated SSID, which is unique to said mobile device.
